(19) United States
(12) Patent Application Publication
(10) Pub. No.: US 2018/0361837 A1
(43) Pub. Date: Dec. 20, 2018

(54) Trailer Covering System

(71) Applicant: Freddie Stallings, S. St Paul, MN (US)

(72) Inventor: Freddie Stallings, S. St Paul, MN (US)

(21) Appl. No.: 15/628,324

(22) Filed: Jun. 20, 2017

(51) Int. Cl. B60J 7/10; B60P 7/04

(52) U.S. Cl. CPC B60J 7/104; B60P 7/02; B60J 7/102; B60P 7/04

(57) ABSTRACT

A trailer covering system for selectively covering an open trailer includes a trailer for transporting cargo. A frame is coupled to and extends upwardly from the trailer. A support unit is removably coupled to and extends upwardly from the frame. A cover unit is removably positioned on the support unit to cover the cargo on the trailer. The cover unit is comprised of a fluid impermeable material to shield the cargo from precipitation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to covering devices and more particularly pertains to a new covering device for selectively covering an open trailer.

### BRIEF SUMMARY OF THE INVENTION

An embodiment of the disclosure meets the needs presented above by generally comprising a trailer for transporting cargo. A frame is coupled to and extends upwardly from the trailer. A support unit is removably coupled to and extends upwardly from the frame. A cover unit is removably positioned on the support unit to cover the cargo on the trailer. The cover unit is comprised of a fluid impermeable material to shield the cargo from precipitation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a support unit and a trailer of a trailer covering system according to an embodiment of the disclosure.

FIG. 2 is a perspective phantom view of an embodiment of the disclosure.

FIG. 3 is a right side phantom view of an embodiment of the disclosure.

FIG. 4 is a right side view of support unit and a trailer of an embodiment of the disclosure.

FIG. 5 is a cross sectional view taken along line 5-5 of FIG. 3 of an embodiment of the disclosure.

### DETAILED DESCRIPTION OF THE INVENTION

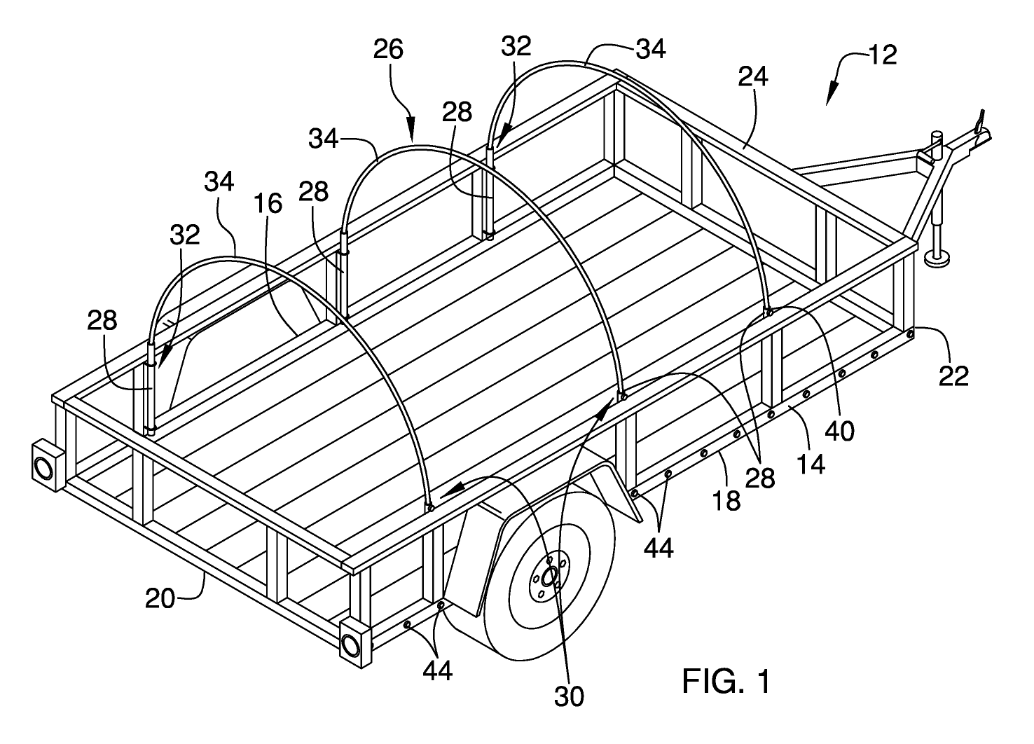

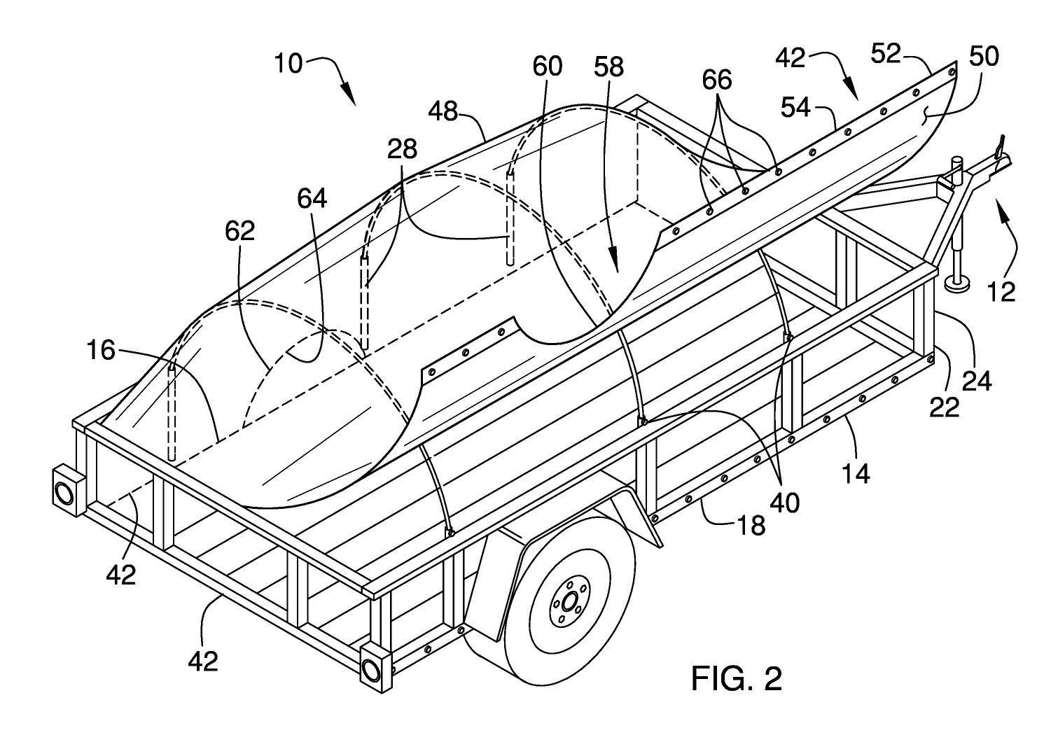

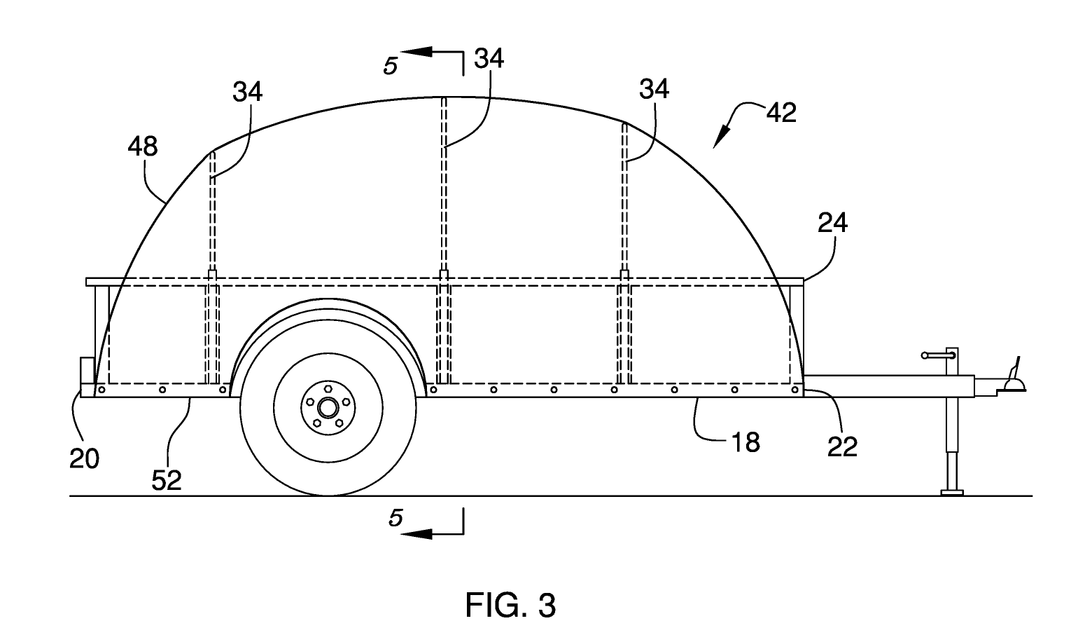

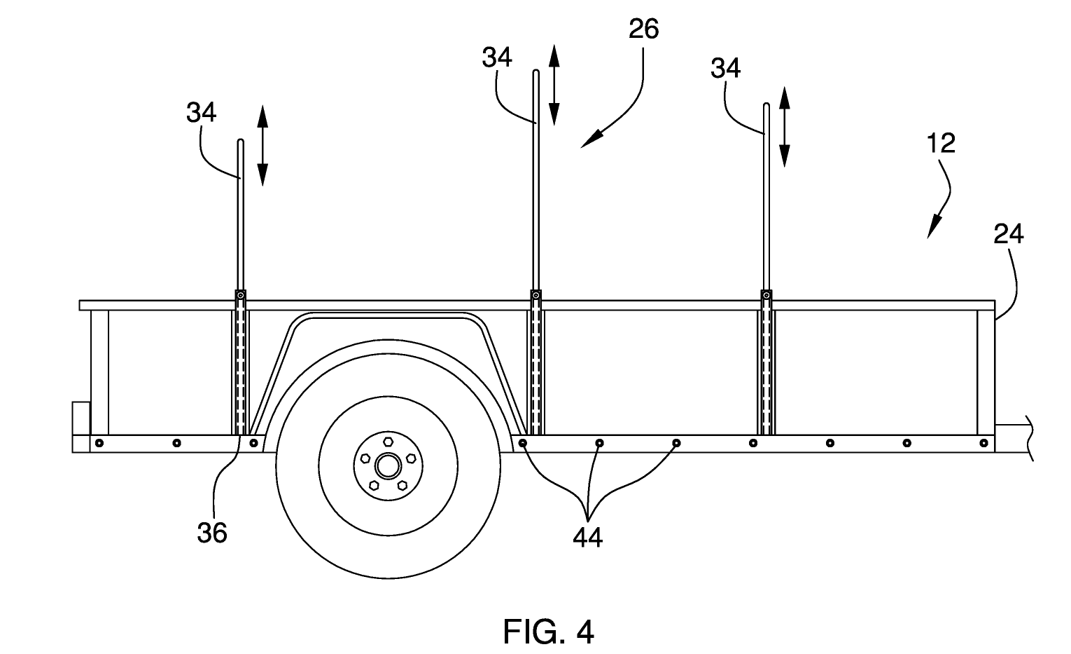

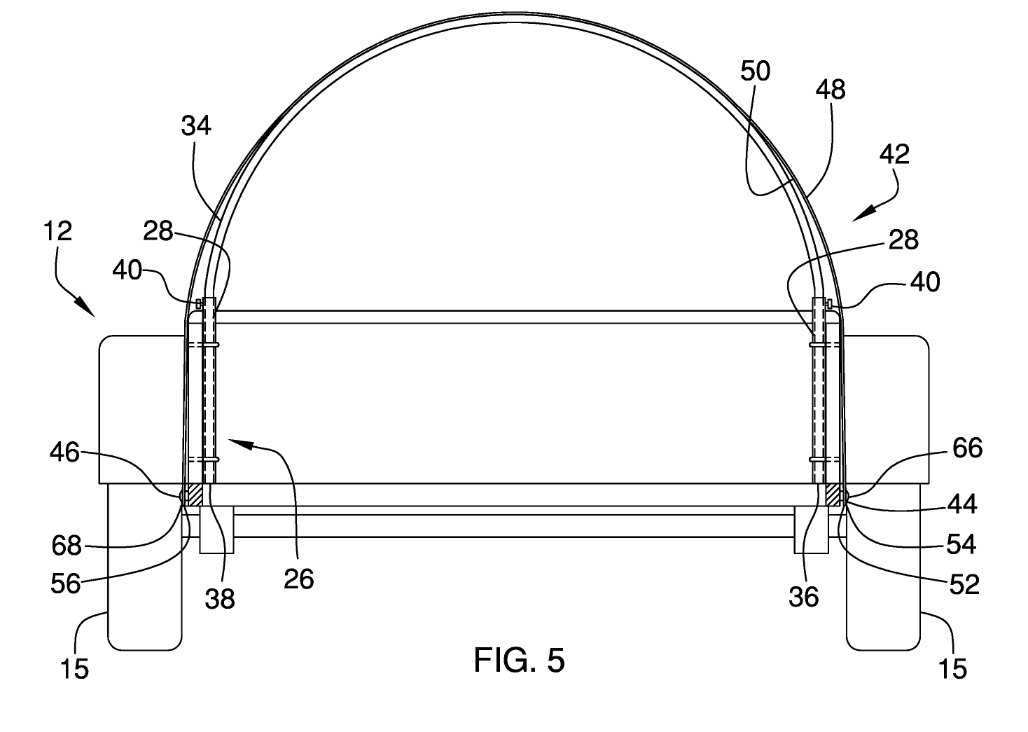

With reference now to the drawings, and in particular to FIGS. 1 through 5 thereof, a new covering device embodying the principles and concepts of an embodiment of the disclosure and generally designated by the reference numeral 10 will be described.

As best illustrated in FIGS. 1 through 5, the trailer covering system 10 generally comprises a trailer 12 for transporting cargo. The trailer 12 has a perimeter edge 14 and a plurality of wheels 15. The perimeter edge 14 has a first lateral side 16, a second lateral side 18, a back side 20 and a front side 22. A frame 24 is coupled to and extends upwardly from the trailer 12. The frame 24 is coextensive with the perimeter edge 14 to retain the cargo on the trailer 12. The trailer 12 may an uncovered, open sided trailer of any conventional design.

A support unit 26 is provided and the support unit 26 is removably coupled to and extends upwardly from the frame 24. The support unit 26 comprises a plurality of tubes 28. Each of the tubes 28 is coupled to the frame 24 and each of the tubes 28 is vertically oriented on the frame 24. The plurality of tubes 28 includes a set of first tubes 30 and a set of second tubes 32. Each of the first tubes 30 is spaced apart from each other and is distributed along the first lateral side 16 of the trailer 12. Additionally, each of the second tubes 32 is spaced apart from each other and is distributed along the second lateral side 18 of the trailer 12. Each of the first tubes 30 is aligned with an associated one of the second tubes 32 and each of the tubes 28 may be removably coupled to the frame 24 with U-bolts or the like.

A plurality of rods 34 is provided and each of the rods 34 has a first end 36 and a second end 38. Moreover, each of the rods 34 is concavely arcuate between the first 36 and second 38 ends. Each of the first tubes 30 insertably receives the first end 36 of an associated one of the rods 34. Each of the second tubes 32 insertably receives the second end 38 of an associated one of the rods 34. Thus, each of the rods 34 forms an arc extending between the first 30 and second 32 tubes.

A plurality of fasteners 40 is provided and each of the fasteners 40 is movably coupled to an associated one of the tubes 28 and each of the fasteners 40 is selectively manipulated. Each of the fasteners 40 frictionally engages the rod corresponding to each of the tubes 28 such that an apex of the corresponding rod 34 is retained a selected distance above the trailer 12. Each of the fasteners 40 may comprise a threaded bolt or the like.

A cover unit 42 is removably positioned on the support unit 26 to cover the cargo on the trailer 12. The cover unit 42 is comprised of a fluid impermeable material to shield the object from precipitation. The cover unit 42 comprises a plurality of first couplers 44 each of the first couplers 44 is coupled to the first lateral side of the trailer 12. Each of the first couplers 44 is spaced apart from each other and is distributed along the first lateral side 16 of the trailer 12 and each of the first couplers 44 may comprise a button snap or the like. A plurality of second couplers 46 is provided and each of the second couplers 46 is coupled to the second lateral side of the trailer 12. Each of the second couplers 46 is spaced apart from each other and is distributed along the second lateral side 18 of the trailer 12. Each of the second couplers 46 may comprise a button snap or like.

A tarp 48 is provided that has a first surface 50 and a perimeter edge 52. The perimeter edge 52 of the tarp 48 has a first lateral side 54 and a second lateral side 56. The tarp 48 is selectively positioned on the rods 34 having the first surface 50 abutting the rods 34. Moreover, the tarp 48 extends between the first lateral side 16, the second lateral side 18, the back side 20 and the front side 22 of the trailer 12.

The tarp 48 has a first cut out 58 extending upwardly from the first lateral side 54 of the tarp 48. The first cut out 58 has a bounding edge 60 and the bounding edge 60 is concavely arcuate with respect to the first lateral side 54 of the tarp 48. Moreover, the first cut out 58 is positioned around an associated one of the wheels 15 when the tarp 48 is positioned on the rods 34. The tarp 48 has a second cut out 62 extending upwardly from the second lateral side of the second lateral side. The second cut out 62 has a bounding edge 64 and the bounding edge 64 of the second cut out 62 is concavely arcuate with respect to the second lateral side 56 of the tarp 48. Moreover, the second cut out 62 is positioned around an associated one of the wheels 15 when the tarp 48 is positioned on the rods 34.

A plurality of third couplers 66 is provided and each of the third couplers 66 is coupled to the first surface 50 of the tarp 48. Each of the third couplers 66 is spaced apart from each other and is distributed along the first lateral side 54 of the tarp 48. Moreover, each of the third couplers 66 releasably engages an associated one of the first couplers 44 to retain the tarp 48 on the rods 34. A plurality of fourth couplers 68 is provided and each of the fourth couplers 68 is coupled to the first surface 50 of the tarp 48. Each of the fourth couplers 68 is spaced apart from each other and is distributed along the second lateral side of the tarp 48. Additionally, each of the fourth couplers 68 releasably engages an associated one of the second couplers 46 to retain the tarp 48 on the rods 34. Each of the third 66 and fourth 68 couplers may comprise button snaps or the like.

In use, the first 36 and second 38 ends of each of the rods 34 are inserted into the associated tubes 28 to form the arc. Each of the fasteners 40 is manipulated to retain the rods 34 in each of the tubes 28. The tarp 48 is positioned over the rods 34 to cover the trailer 12. Each of the first couplers 44 is manipulated to engage the third couplers 66. Each of second couplers 46 is manipulated to engage the fourth couplers 68. Thus, the tarp 48 is retained on the trailer 12. The tarp 48, the rods 34 and each of the tubes 28 are removable from the trailer 12 at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A trailer covering system comprising:
a trailer being configured to transport cargo, said trailer having a first lateral side, a second lateral side, and an upper surface extending between said first lateral side and said second lateral side;
a frame being coupled to and extending upwardly from said trailer;
a support unit being removably coupled to and extending upwardly from said frame, said support unit comprising
a plurality of tubes, each of said tubes being coupled to said frame having each of said tubes being vertically oriented on said frame, each of said tubes having a proximal end relative to said frame being positioned substantially coplanar with said upper surface of said trailer, each of said tubes having a distal end relative to said frame being positioned vertically spaced above a top of said frame, said plurality of tubes including a set of first tubes and a set of second tubes, each of said first tubes being spaced apart from each other and being distributed along said first lateral side, each of said second tubes being spaced apart from each other and being distributed along said second lateral side, each of said first tubes being aligned with an associated one of said second tubes,
a plurality of rods, each of said rods having a first end and a second end, each of said rods being concavely arcuate between said first and second ends, each of said first tubes insertably receiving said first end of an associated one of said rods, each of said second tubes insertably receiving said second end of an associated one of said rods having each of said rods forming an arc between said first and second ends, and
a plurality of fasteners, each of said fasteners being movably coupled to an associated one of said tubes between said distal end of said associated one of said tubes and said top of said frame wherein each of said fasteners is configured to be manipulated, each of said fasteners frictionally engaging said rod corresponding to each of said tubes such that an apex of said corresponding rod is retained a selected distance from said trailer; and
a cover unit being removably positioned on said support unit wherein said cover unit is configured to cover the cargo in said trailer, said cover unit being comprised of a fluid impermeable material wherein said cover unit is configured to shield the cargo from precipitation.

2. The assembly according to claim 1, wherein:
said trailer has a perimeter edge and a plurality of wheels, said perimeter edge having a back side and a front side; and
said frame is coextensive with said perimeter edge wherein said frame is configured to retain the object on said trailer.

3. (canceled)

4. (canceled)

5. (canceled)

6. (canceled)

7. The assembly according to claim 2, further comprising said cover unit comprises a plurality of first couplers, each of said first couplers being coupled to said first lateral side of said trailer, each of said first couplers being spaced apart from each other and being distributed along said first lateral side.

8. The assembly according to claim 7, further comprising a plurality of second couplers, each of said second couplers being coupled to said second lateral side of said trailer, each of said couplers being spaced apart from each other and being distributed along said second lateral side.

9. The assembly according to claim 1, further comprising said cover unit including a tarp having a first surface and a perimeter edge, said perimeter edge of said tarp having a first lateral side and a second lateral side, said tarp being selectively positioned on said rods having said first surface abutting said rods, said tarp extending between a first lateral side, a second lateral side, a back side and a front side of said trailer.

10. The assembly according to claim 9, wherein said tarp has a first cut out extending upwardly from said first lateral side of said tarp, said first cut out having a bounding edge, said bounding edge being concavely arcuate with respect to said first lateral side of said tarp, said first cut out being positioned around an associated one of said wheels when said tarp is positioned on said rods.

11. The assembly according to claim 10, wherein said tarp has a second cutout extending upwardly from said second lateral side of said tarp, said second cut out having a bounding edge, said bounding edge of said second cut out being concavely arcuate with respect to said second lateral side of said tarp, said second cut out being positioned around an associated one of said wheels when said tarp is positioned on said rods.

12. The assembly according to claim 8, said cover unit further comprising:
a tarp having a first surface and a first lateral side; and
a plurality of third couplers, each of said third couplers being coupled to said first surface of said tarp, each of said third couplers being spaced apart from each other and being distributed along said first lateral side of said tarp, each of said third couplers releasably engaging an associated one of said first couplers to retain said tarp on said rods.

13. The assembly according to claim 12, further comprising:
said tarp having a second lateral side; and
a plurality of fourth couplers, each of said fourth couplers being coupled to said first surface of said tarp, each of said fourth couplers being spaced apart from each other and being distributed along said second lateral side of said tarp, each of said fourth couplers releasably engaging an associated one of said second couplers to retain said tarp on said rods.

14. A trailer covering system comprising:
a trailer being configured to transport cargo, said trailer having a first lateral side, a second lateral side, and an upper surface extending between said first lateral side and said second lateral side, said trailer having a perimeter edge and a plurality of wheels, said perimeter edge having a back side and a front side;
a frame being coupled to and extending upwardly from said trailer, said frame being coextensive with said perimeter edge wherein said frame is configured to retain the cargo on said trailer;
a support unit being removably coupled to and extending upwardly from said frame, said support unit comprising:
a plurality of tubes, each of said tubes being coupled to said frame having each of said tubes being vertically oriented on said frame, each of said tubes having a proximal end relative to said frame being positioned substantially coplanar with said upper surface of said trailer, each of said tubes having a distal end relative to said frame being positioned vertically spaced above a top of said frame, said plurality of tubes including a set of first tubes and a set of second tubes, each of said first tubes being spaced apart from each other and being distributed along said first lateral side, each of said second tubes being spaced apart from each other and being distributed along said second lateral side, each of said first tubes being aligned with an associated one of said second tubes,
a plurality of rods, each of said rods having a first end and a second end, each of said rods being concavely arcuate between said first and second ends, each of said first tubes insertably receiving said first end of an associated one of said rods, each of said second tubes insertably receiving said second end of an associated one of said rods having each of said rods forming an arc between said first and second tubes, and
a plurality of fasteners, each of said fasteners being movably coupled to an associated one of said tubes between said distal end of said associated one of said tubes and said top of said frame wherein each of said fasteners is configured to be manipulated, each of said fasteners frictionally engaging said rod corresponding to each of said tubes such that an apex of said corresponding rod is retained a selected distance from said trailer; and
a cover unit being removably positioned on said support unit wherein said cover unit is configured to cover the cargo on said trailer, said cover unit being comprised of a fluid impermeable material wherein said cover unit is configured to shield the cargo from precipitation, said cover unit comprising:
a plurality of first couplers, each of said first couplers being coupled to said first lateral side of said trailer, each of said first couplers being spaced apart from each other and being distributed along said first lateral side,
a plurality of second couplers, each of said second couplers being coupled to said second lateral side of said trailer, each of said second couplers being spaced apart from each other and being distributed along said second lateral side,
a tarp having a first surface and a perimeter edge, said perimeter edge of said tarp having a first lateral side and a second lateral side, said tarp being selectively positioned on said rods having said first surface abutting said rods, said tarp extending between said first lateral side, said second lateral side said back side and said front side of said trailer, said tarp having a first cut out extending upwardly from said first lateral side of said tarp, said first cut out having a bounding edge, said bounding edge being concavely arcuate with respect to said first lateral side of said tarp, said first cut out being positioned around an associated one of said wheels when said tarp is positioned on said rods, said tarp having a second cutout extending upwardly from said second lateral side of said second lateral side, said second cut out having a bounding edge, said bounding edge of said second cut out being concavely arcuate with respect to said second lateral side of said tarp, said second cut out being positioned around an associated one of said wheels when said tarp is positioned on said rods,
a plurality of third couplers, each of said third couplers being coupled to said first surface of said tarp, each of said third couplers being spaced apart from each other and being distributed along said first lateral side of said tarp, each of said third couplers releasably engaging an associated one of said first couplers to retain said tarp on said rods, and
a plurality of fourth couplers, each of said fourth couplers being coupled to said first surface of said tarp, each of said fourth couplers being spaced apart from each other and being distributed along said second lateral side of said tarp, each of said fourth couplers releasably engaging an associated one of said second couplers to retain said tarp on said rods.
